(19) United States
(12) Patent Application Publication
(10) Pub. No.: US 2023/0214479 A1
(43) Pub. Date: Jul. 6, 2023

(54) METHOD AND SYSTEM FOR DETECTING AND PREVENTING UNAUTHORIZED ACCESS TO A COMPUTER

(71) Applicant: Saudi Arabian Oil Company, Dhahran (SA)

(72) Inventor: Urfan Ahmed, Dhahran (SA)

(21) Appl. No.: 17/646,940

(22) Filed: Jan. 4, 2022

(51) Int. Cl. G06F 21/51; G06F 21/55; G06F 21/53

(52) U.S. Cl. CPC G06F 21/51; G06F 21/554; G06F 21/552; G06F 21/53; G06F 2221/2101; G06F 2221/033

(57) ABSTRACT

A system and method detecting and prevent unauthorized access to a computer. The method is configured to control access to the computer. The computer operates in a learning mode including listing, in a whitelist in a memory of the computer, an executable application in the computer, and operating the computer in a protected mode. During operation of the computer in the protected mode, the method detects a first application in the computer, wherein the first application is transferred from a first external resource operatively connected to the computer, suspend execution of the first application, determine whether the first application is in the whitelist, and if the first application is in the whitelist, allowing the first application to be executed, thereby controlling the access of the first application to the computer. The system implements the method using a monitoring sub-system in the computer.

### FIELD OF THE DISCLOSURE

The present disclosure relates generally to accessing computer resources, and, more particularly, to a system and method for detecting and preventing unauthorized access to a computer.

### BACKGROUND OF THE DISCLOSURE

The security of computer systems can be compromised through diverse methods. One such method involves malware which, upon breaching a computer system, executes and pervades the computer system, doing damage such as erasing data, and otherwise interfering with the operation of the computer system. Since such malware often invades a computer system through a network connection, network intrusion systems can monitor data packets at the network connection. However, such network connection monitoring is less effective if intrusive malware is encrypted.

Another method of compromising a computer system involves an attacker which gains a network connection to a computer system when a computer resource associated with the computer system attempts to connect to an untrusted network or external resource that has not been whitelisted previously.

### SUMMARY OF THE DISCLOSURE

According to an embodiment consistent with the present disclosure, a system and method for detecting and preventing unauthorized access to a computer.

In an embodiment, a method is configured to control access to a computer, and comprises operating the computer in a learning mode including listing, in a whitelist in a memory of the computer, an executable application in the computer; and operating the computer in a protected mode. During operation of the computer in the protected mode, the method detects a first application in the computer, wherein the first application is transferred from a first external resource operatively connected to the computer, suspend execution of the first application, determine whether the first application is in the whitelist, and if the first application is in the whitelist, allowing the first application to be executed, thereby controlling the access of the first application to the computer.

Operating the computer in the learning mode further comprises identifying a second application in the computer, and updating the whitelist to include the second application. The first external resource is selected from the group consisting of: a network, a server, and a database. Each application is selected from the group consisting of: an app, an applet, a computer process, a dynamic-link library (DLL), a subroutine, and an operating system. When the computer is in the learning mode, the method determines a first value of a first amount of data transferred between the computer and a second external resource during execution of a third application, and stores the first value in the memory. When the computer is in the protected mode, the method determines a second value of a second amount of data transferred between the computer and a third external resource during execution of the third application, retrieves the first value from the memory, determines whether the second value exceeds the first value by a predetermined threshold, and if the second value exceeds the first value by the predetermined threshold, suspends execution of the third application. The predetermined threshold is one percent.

In another embodiment, a computer is configured to control access thereto, and comprises a memory configured to store a whitelist in an application repository, and a monitoring sub-system. The monitoring sub-system includes software therein configured to operate the computer in a learning mode including listing, in the whitelist, an executable application in the computer, operating the computer in a protected mode including detecting a first application in the computer, wherein the first application is transferred from a first external resource operatively connected to the computer, suspending execution of the first application, determining whether the first application is in the whitelist, and if the first application is in the whitelist, allowing the first application to be executed, thereby controlling the access of the first application to the computer.

The monitoring sub-system is configured to identify a second application in the computer, and to update the whitelist to include the second application. The first external resource is selected from the group consisting of: a network, a server, and a database. Each application is selected from the group consisting of: an app, an applet, a computer process, a dynamic-link library (DLL), a subroutine, and an operating system. When the computer is in the learning mode, the monitoring sub-system is configured to determine a first value of a first amount of data transferred between the computer and a second external resource during execution of a third application, and to store the first value in the memory. When the computer is in the protected mode, the monitoring sub-system is configured to determine a second value of a second amount of data transferred between the computer and a third external resource during execution of the third application, to retrieve the first value from the memory, to determine whether the second value exceeds the first value by a predetermined threshold, and if the second value exceeds the first value by the predetermined threshold, to suspend execution of the third application. The predetermined threshold is one percent.

In a further embodiment, a system comprises a first resource and a computer. The computer includes a memory configured to store a whitelist in an application repository, and a monitoring sub-system. The monitoring sub-system including software therein configured to operate the computer in a learning mode including listing, in the whitelist, an executable application in the computer, operating the computer in a protected mode including detecting a first application in the computer, wherein the first application is transferred from a first resource operatively connected to the computer, suspending execution of the first application, determining whether the first application is in the whitelist, and if the first application is in the whitelist, allowing the first application to be executed, thereby controlling the access of the first application to the computer.

The monitoring sub-system is configured to identify a second application in the computer, and to update the whitelist to include the second application. The first resource is selected from the group consisting of: a network, a server, and a database. Each application is selected from the group consisting of: an app, an applet, a computer process, a dynamic-link library (DLL), a subroutine, and an operating system. When the computer is in the learning mode, the monitoring sub-system is configured to determine a first value of a first amount of data transferred between the computer and a second resource during execution of a third application, and to store the first value in the memory. When the computer is in the protected mode, the monitoring sub-system is configured to determine a second value of a second amount of data transferred between the computer and a third resource during execution of the third application, to retrieve the first value from the memory, to determine whether the second value exceeds the first value by a predetermined threshold, and if the second value exceeds the first value by the predetermined threshold, to suspend execution of the third application.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a schematic of a system, according to an embodiment.

FIG. 2 is a flowchart of operation of the system in a learning mode.

FIG. 3 is a flowchart of operation of the system in a protected mode.

It is noted that the drawings are illustrative and are not necessarily to scale.

### DETAILED DESCRIPTION OF CERTAIN EMBODIMENTS OF THE DISCLOSURE

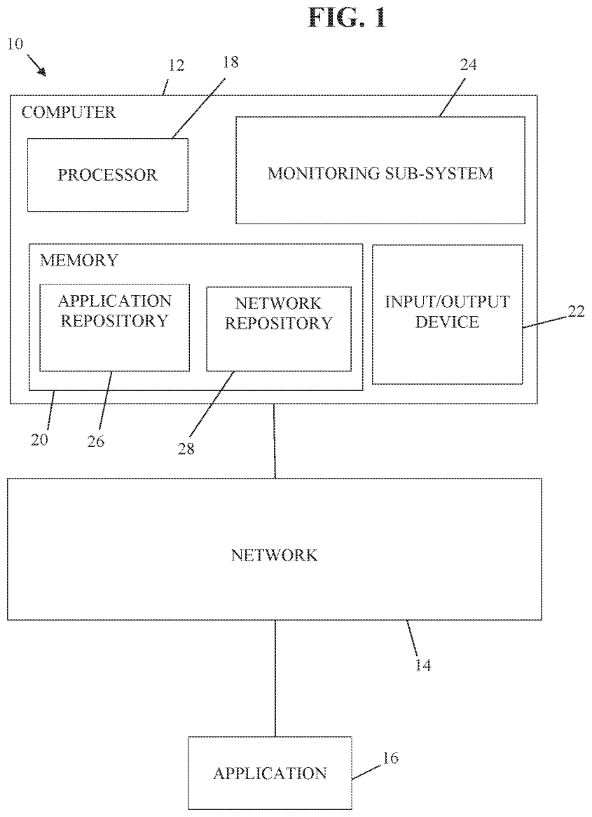

Example embodiments consistent with the teachings included in the present disclosure are directed to a system and method for detecting and preventing unauthorized access to a computer. As shown in FIG. 1, the system 10 includes the computer 12 operatively connected to a resource 14, which transfers an application 16 to the computer 12 for execution. The computer 12 can be a personal computer. Alternatively, the computer 12 can be a laptop. Also, the computer 12 can be a tablet. In addition, the computer 12 can be a smartphone. Furthermore, the computer 12 can be a server.

The resource 14 can be a network. The network can be the Internet. Alternatively, the network can be a local area network (LAN). In addition, the network can be a wide area network (WAN). Alternatively, the resource 14 can be a server. Furthermore, the resource 14 can be a database. The application 16 can be executable software. Alternatively, the application 16 can be an app. Also, the application 16 can be an applet. Furthermore, the application 16 can be a computer process. In addition, the application 16 can be a dynamic-link library (DLL). Also, the application 16 can be a subroutine. The application 16 can also be an operating system.

Referring to FIG. 1, the computer 12 includes a processor 18, a memory 20, an input/output device 22, and a monitoring sub-system 24. The processor 18 can be a microprocessor. The memory 20 can be volatile memory. Also, the memory 20 can be non-volatile memory. The memory 20 includes an application repository 26. The memory 20 can also include a network repository 28. The input/output device 22 can be a communication interface configured to establish communications between the computer 12 and the resource 14. The input/output device 22 can be a display. The input/output device 22 can also be a keyboard. The input/output device 22 can also be a mouse. The input/output device 22 can also be a touchscreen.

The application repository 26 can store a whitelist of applications installed on the computer 12. Alternatively, the whitelist can list applications 16 considered safe to execute on the computer 12. The application repository 26 can also store names and dates of installed applications, process and DLL names, machine names, file locations, and hashes of the files. The network repository 28 can store a list of connections to the resource 14.

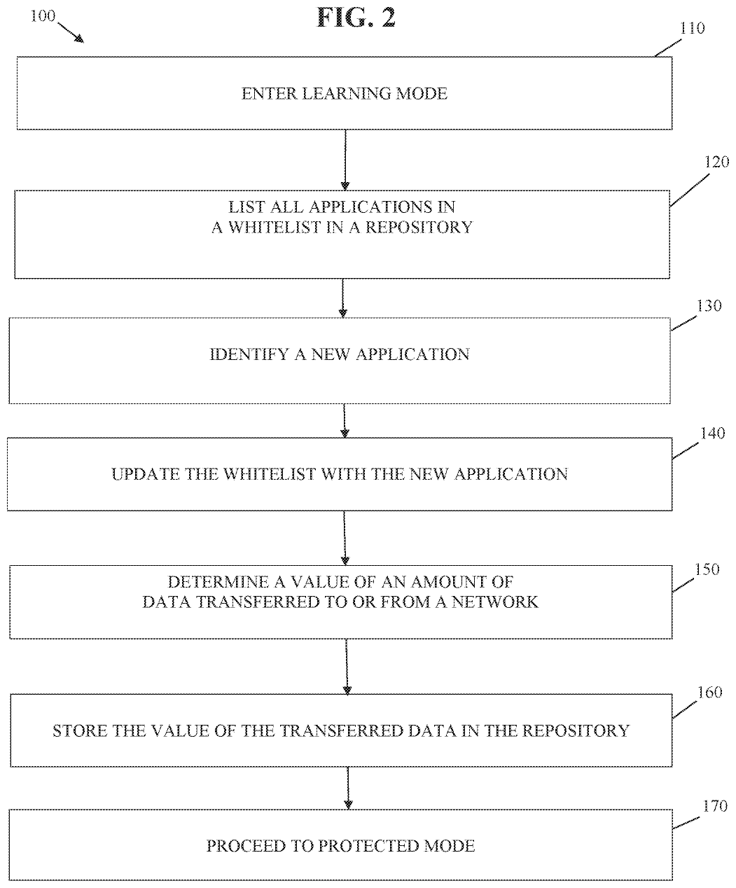

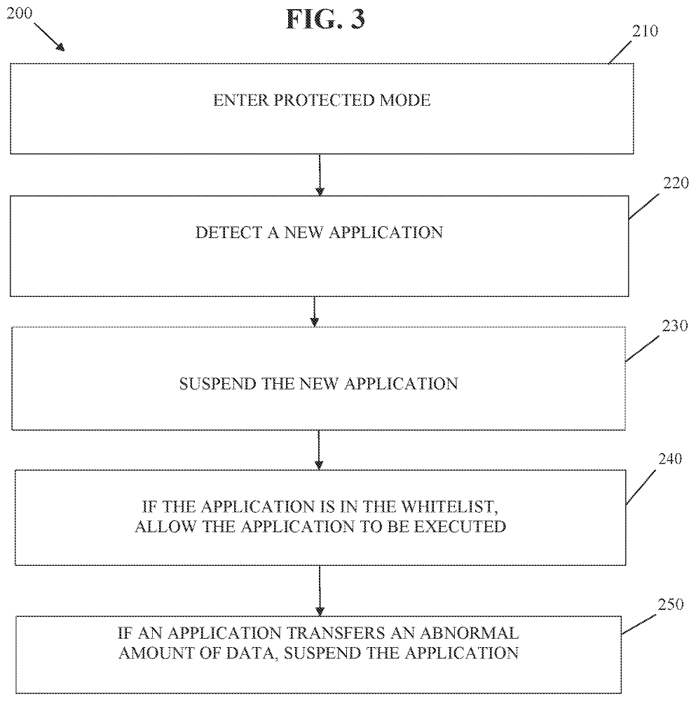

The system 10 implements methods 100, 200, shown in FIGS. 2-3, respectively, to operate in a learning mode and in a protected mode, respectively. In particular, the monitoring sub-system 24 performs the methods 100, 200. Referring to FIG. 2, the method 100 enters the learning mode in step 110, and lists all applications in the computer 12 in the whitelist in the application repository 26 in step 120. In listing all applications, the method 100 checks for any installed applications, computer process names, application or process hashes, application or process canonical paths, as well as any apps, applets, subroutines, operating systems, network connections, etc. The method 100 then identifies a new application, such as the application 16, which has been transferred to and resides on the computer 12, in step 130. The method 100 updates the whitelist with the new application in step 140. In learning mode, the method 100 can also determine a value of an amount of data transferred between the computer 12 and the resource 14, such as a network, in step 150. The method 100 can then store the value of the transferred data in the network repository 28 in step 160. The method 100 then proceeds to enter the protected mode in step 170.

Referring to FIG. 3, the method 200 enters the protected mode in step 210, and detects a new application such as another application 16 in step 220. The method 200 then provisionally suspends the new application from being executed, in step 230. The method 200 determines if the new application is in the whitelist in step 240. If so, the monitoring sub-system 24 allows the new application to be executed by the computer 12 in step 240. Also, the method 200 determines if an application transfers an abnormal amount of data between the computer 12 and the resource 14, such as a network, in step 250. If so, the method 200 suspends execution of the application in step 250. The abnormal amount can be determined if the value of the amount exceeds a predetermined threshold relative to an amount of data in a previously performed data transfer. For example, the predetermined threshold can be one percent.

In addition, the system 10 can implement and maintain an event log in the memory 20, allowing an administrator to monitor and review the operations of the monitoring sub-system 24 and any suspensions of execution of applications. Based on such a review by an administrator, the administrator can manually override the suspension of a particular application using the input/output device 22. For example, the administrator can deem an application to be safe for execution.

In another embodiment, when the system 10 suspends an application from being executed, the system 10 flags the application in the memory 20, and notifies and alerts an administrator of such a flagged application. Such flagging of applications allows the administrator to monitor and review the suspended application.

Portions of the methods described herein can be performed by software or firmware in machine readable form on a tangible (e.g., non-transitory) storage medium. For example, the software or firmware can be in the form of a computer program including computer program code adapted to cause the system to perform various actions described herein when the program is run on a computer or suitable hardware device, and where the computer program can be embodied on a computer readable medium. Examples of tangible storage media include computer storage devices having computer-readable media such as disks, thumb drives, flash memory, and the like, and do not include propagated signals. Propagated signals can be present in a tangible storage media. The software can be suitable for execution on a parallel processor or a serial processor such that various actions described herein can be carried out in any suitable order, or simultaneously.

It is to be further understood that like or similar numerals in the drawings represent like or similar elements through the several figures, and that not all components or steps described and illustrated with reference to the figures are required for all embodiments or arrangements.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A method configured to control access to a computer, comprising:
operating the computer in a learning mode including:
listing, in a whitelist in a memory of the computer, an executable application in the computer; and
operating the computer in a protected mode including:
detecting a first application in the computer, wherein the first application is transferred from a first external resource operatively connected to the computer;
suspending execution of the first application;
determining whether the first application is in the whitelist; and
if the first application is in the whitelist, allowing the first application to be executed, thereby controlling the access of the first application to the computer.

2. The method of claim 1, wherein operating the computer in the learning mode further comprises:
identifying a second application in the computer; and
updating the whitelist to include the second application.

3. The method of claim 1, wherein the first external resource is selected from the group consisting of: a network, a server, and a database.

4. The method of claim 1, wherein each application is selected from the group consisting of: an app, an applet, a computer process, a dynamic-link library (DLL), a subroutine, and an operating system.

5. The method of claim 1, further comprising:
when the computer is in the learning mode, determining a first value of a first amount of data transferred between the computer and a second external resource during execution of a third application; and
storing the first value in the memory.

6. The method of claim 5, further comprising:
when the computer is in the protected mode, determining a second value of a second amount of data transferred between the computer and a third external resource during execution of the third application;
retrieving the first value from the memory;
determining whether the second value exceeds the first value by a predetermined threshold; and
if the second value exceeds the first value by the predetermined threshold, suspending execution of the third application.

7. The method of claim 6, wherein the predetermined threshold is one percent.

8. A computer configured to control access thereto, comprising:
a memory configured to store a whitelist in an application repository; and
a monitoring sub-system including software therein configured to operate the computer in a learning mode including listing, in the whitelist, an executable application in the computer, operating the computer in a protected mode including detecting a first application in the computer, wherein the first application is transferred from a first external resource operatively connected to the computer, suspending execution of the first application, determining whether the first application is in the whitelist, and if the first application is in the whitelist, allowing the first application to be executed, thereby controlling the access of the first application to the computer.

9. The computer of claim 8, wherein the monitoring sub-system is configured to identify a second application in the computer, and to update the whitelist to include the second application.

10. The computer of claim 8, wherein the first external resource is selected from the group consisting of: a network, a server, and a database.

11. The computer of claim 8, wherein each application is selected from the group consisting of: an app, an applet, a computer process, a dynamic-link library (DLL), a subroutine, and an operating system.

12. The computer of claim 8, wherein, when the computer is in the learning mode, the monitoring sub-system is configured to determine a first value of a first amount of data transferred between the computer and a second external resource during execution of a third application, and to store the first value in the memory.

13. The computer of claim 12, wherein, when the computer is in the protected mode, the monitoring sub-system is configured to determine a second value of a second amount of data transferred between the computer and a third external resource during execution of the third application, to retrieve the first value from the memory, to determine whether the second value exceeds the first value by a predetermined threshold, and if the second value exceeds the first value by the predetermined threshold, to suspend execution of the third application.

14. The computer of claim 13, wherein the predetermined threshold is one percent.

15. A system, comprising:
a first resource; and
a computer including:
a memory configured to store a whitelist in an application repository; and
a monitoring sub-system including software therein configured to operate the computer in a learning mode including listing, in the whitelist, an executable application in the computer, operating the computer in a protected mode including detecting a first application in the computer, wherein the first application is transferred from a first resource operatively connected to the computer, suspending execution of the first application, determining whether the first application is in the whitelist, and if the first application is in the whitelist, allowing the first application to be executed, thereby controlling the access of the first application to the computer.

16. The system of claim 15, wherein the monitoring sub-system is configured to identify a second application in the computer, and to update the whitelist to include the second application.

17. The system of claim 15, wherein the first resource is selected from the group consisting of: a network, a server, and a database.

18. The system of claim 15, wherein each application is selected from the group consisting of: an app, an applet, a computer process, a dynamic-link library (DLL), a subroutine, and an operating system.

19. The system of claim 15, wherein, when the computer is in the learning mode, the monitoring sub-system is configured to determine a first value of a first amount of data transferred between the computer and a second resource during execution of a third application, and to store the first value in the memory.

20. The system of claim 19, wherein, when the computer is in the protected mode, the monitoring sub-system is configured to determine a second value of a second amount of data transferred between the computer and a third resource during execution of the third application, to retrieve the first value from the memory, to determine whether the second value exceeds the first value by a predetermined threshold, and if the second value exceeds the first value by the predetermined threshold, to suspend execution of the third application.
